(19) United States
(12) Patent Application Publication
(10) Pub. No.: US 2013/0141726 A1
(43) Pub. Date: Jun. 6, 2013

(54) SENSING DEVICE FOR DETECTING A SUBSTANCE IN A FLUID

(71) Applicants: Ron Martinus Laurentius Van Lieshout, Geldrop (NL); Roel Penterman, Eindhoven (NL)

(72) Inventors: Ron Martinus Laurentius Van Lieshout, Geldrop (NL); Roel Penterman, Eindhoven (NL)

(73) Assignee: KONINKLIJKE PHILIPS ELECTRONICS N.V., EINDHOVEN (NL)

(21) Appl. No.: 13/695,828

(22) PCT Filed: Apr. 26, 2011
(86) PCT No.: PCT/IB2011/051797

§ 371 Date: Jan. 8, 2013

(30) Foreign Application Priority Data
May 3, 2010 (EP) 10161742.1

(51) Int. Cl. G01N 21/55

(52) U.S. Cl. CPC G01N 21/55
USPC 356/436; 29/428

(57) ABSTRACT

The invention relates to a sensing device (1) for detecting a substance (3) in a fluid (6), wherein the sensing device (1) comprises a sensing region (2) for being used for generating a sensing signal depending on the substance, a reference region (4) for being used for providing a reference signal, and a reference element (5) covering the reference region (4). The reference element (5) is adapted to shield the reference region (4) from the substance (3) and to allow the fluid (6) to penetrate the reference element (5). This reduces the influence of the reference signal by the substance (3) and, since the reference element (5) is adapted to allow the fluid (6) to penetrate the reference element (5), differences regarding properties of the fluid (6) at the sensing region (2) and of the reference element (5) at the reference region (4) can be reduced. This reduction leads to an improved reference signal, which can be used, for example, for correcting the sensing signal.

### FIELD OF THE INVENTION

The present invention relates to a sensing device and an analyzing device for sensing a substance in a fluid. The invention further relates to a corresponding sensing method for sensing the substance in the fluid, and to a manufacturing method for manufacturing the sensing device.

### BACKGROUND OF THE INVENTION

U.S. Pat. No. 7,317,534 B2 discloses a measuring method comprising a measuring unit with a film layer having a sensing region where a target molecule can be fixed to the surface thereof and a reference region where a target molecule should not be fixed to the surface. A photodetector generates a sensing signal depending on the intensity of a light beam reflected in total internal reflection at the sensing region and a reference signal depending on the intensity of a light beam reflected in total internal reflection at the reference region. The sensing signal is corrected depending on the reference signal.

### SUMMARY OF THE INVENTION

It is an object of the invention to provide a sensing device and an analyzing device for detecting a substance in a fluid that allow for an improved detection of the substance in the fluid. It is a further object of the present invention to provide a corresponding sensing method for detecting a substance in a fluid, and a manufacturing method for manufacturing the sensing device.

In an aspect of the present invention a sensing device for detecting a substance in a fluid is provided, wherein the sensing device comprises
a sensing region for being used for generating a sensing signal depending on the substance,
a reference region for being used for providing a reference signal, and
a reference element covering the reference region, wherein the reference element is adapted to shield the reference region from the substance and to allow the fluid to penetrate the reference element.

The reference element is adapted to shield the reference region such that only a reduced amount of the substance can be present at the reference region, in particular, such that the substance cannot be present at the reference region. The influence of the reference signal by the substance is therefore reduced, in particular, the reference signal is not influenced by the substance. Moreover, since the reference element is adapted to allow the fluid to penetrate the reference element, differences regarding properties of the fluid at the sensing region and of the reference element at the reference region can be reduced. For example, if the reference region and the sensing region are sensed by light for generating a reference signal and a sensing signal, respectively, differences in refractive index between the fluid at the sensing region and the reference element at the reference region can be reduced, if the fluid penetrates the reference element. The reference signal is therefore substantially not affected by the substance to be detected, or this influence by the substance is at least reduced, and an influence on the reference signal by differences in properties at the sensing region and at the reference region is reduced. The reference signal changes therefore substantially depending on other effects like temperature fluctuations, deformations, changes in, for example, the intensity of light used for sensing the reference region and generating the reference signal, et cetera. The reference signal can therefore be used to correct the sensing signal for these other effects and allows thereby to improve the detection of the substance in the fluid.

It is preferred that the reference element is penetrable by the fluid such that the reference element with the absorbed fluid has substantially the same refractive index as the fluid. It is further preferred that the reference element is or comprises a polymer and/or a hydrogel. The hydrogel is preferentially a <50 percent hydrogel and more preferred a low-weight-percentage hydrogel, i.e. a <20 percent hydrogel, that absorbs the surrounding fluid very well, resulting in a refractive index close to the refractive index of the fluid. The percentage values refer to the percentage by weight of gel material used during manufacturing/polymerization of the hydrogel, i.e. while manufacturing a <50 percent hydrogel, more than 50 percent by weight of water is used, and while manufacturing a <20 percent hydrogel, more than 80 percent per weight of water is used. The gel material is preferentially a polymer gel material.

The reference element allows preferentially a free movement of the fluid, but stops the substance from being arranged at the reference region. In particular, the sensing device is adapted to be used for generating an evanescent field in the sensing region and in the reference region, wherein the sensing region is adapted to be used to generate the sensing signal depending on the presence of the substance in the evanescent field in the sensing region, and wherein the reference element is adapted to shield the reference region such that the substance is prevented from entering the evanescent field in the reference region.

The fluid is preferentially a bodily fluid like blood, urine or saliva and the substance is preferentially a particle, in particular, a magnetic particle, which comprises an attaching element for attaching a target element within the fluid. The amount of particles detected by the sensing device is the measure for the amount of the target elements in the fluid. The sensing device is preferentially a biosensor.

The reference element comprises preferentially an inkjet-printable material and/or a contact-printable material, in particular, an inkjet-printable and/or a contact-printable hydrogel. Such a material can be positioned on a sensing surface with very high accuracy. In other embodiments, the reference element comprises a material which can be used for other techniques that can form a drop, in particular, a small drop, on a surface.

The sensing region comprises preferentially binding elements for binding the substance on the sensing region.

It is further preferred that the reference region is adjacent to the sensing region. The reference region and the sensing region are therefore located close to each other. This ensures that the influences on the reference signal, which are not caused by the substance, also influence the sensing signal. This further improves the detection of the substance in the fluid, if the reference signal is used for correcting the sensing signal, and/or improves a wetting detection, if the reference element is adapted to detect wetting of the sensing region depending on the degree of wetting of the reference region, in particular, of the reference element.

The sensing device can be a cartridge having a carrier comprising a sensing surface on which the sensing region and the reference region are located. The sensing device can also be a device which comprises:
a signal generation unit for sensing the sensing region for generating a sensing signal and for sensing the reference region for generating a reference signal, and
at least one of a) a corrector for correcting the sensing signal depending on the reference signal and b) a wetting determining unit for determining a degree of wetting depending on the reference signal. The signal generation unit is preferentially adapted to generate the sensing signal depending on the presence of the substance in the sensing region.

A property of the reference element can change depending on the degree of penetration of the reference element by the fluid. If the reference signal depends on the property change, the degree of wetting can be determined based on the reference signal. For example, if light is used for sensing the reference region such that the reflected light depends on the refractive index at the reference region and if the refractive index at the reference region changes with the degree of wetting, because the fluid penetrates the reference element, changes in the intensity of the reflected reference signal can be related to the degree of wetting. Firstly, after the fluid has been introduced into the sensing device, the reference signal can be used only for determining the degree of wetting. After the degree of wetting has reached a maximal constant value, the reference signal is not influenced anymore by a change in the degree of wetting and the reference signal can be used for correcting the sensing signal depending on the reference signal. Thus, the sensing device can comprise both, a corrector and a wetting determining unit, wherein firstly the wetting determining unit determines the degree of wetting depending on the reference signal, and, after a maximal constant degree of wetting has been reached, the corrector uses the reference signal for correcting the sensing signal. In addition to or as an alternative to using the reference signal for wetting detection, a wetting region can be provided, which is not the reference region and which can be used for generating a wetting signal, wherein the wetting signal is used for determining the degree of wetting. A wetting element, which corresponds to the reference element described above, is arranged at the wetting region for influencing the wetting signal depending on the degree of wetting.

It is further preferred that the corrector is adapted to correct a drift in the sensing signal depending on the reference signal. The drift correction can be performed, for example, by multiplying a currently generated sensing signal with a factor defined by the ratio of an initially measured reference signal and a currently measured reference signal. The initially measured reference signal is preferentially a reference signal, which has been measured at a predefined, in particular, arbitrary, but fixed time.

It is further preferred that the signal generation unit comprises:
a light source for directing incident light to the sensing region and the reference region such that the incident light is reflected under total internal reflection conditions at the sensing region for generating sensing light and at the reference region for generating reference light, and
a detector for generating the sensing signal depending on the sensing light and for generating the reference signal depending on the reference light. This allows detecting the sensing signal and the reference signal with high accuracy.

It is also preferred that the sensing device is adapted to cooperate with an analyzing device for detecting the substance in the fluid, wherein the analyzing device comprises:
a signal generation unit for sensing the sensing region for generating a sensing signal and for sensing the reference region for generating a reference signal,
at least one of a) a corrector for correcting the sensing signal depending on the reference signal and b) a wetting determining unit for determining a degree of wetting depending on the reference signal. Thus, the sensing device, which is preferentially a cartridge, can be a disposable device, which is preferentially used only one time. The sensing device is therefore not contaminated with fluids and substances of a previous detection procedure. The analyzing device is preferentially used several times with several disposable sensing devices.

It is further preferred that the sensing device is adapted to be used to detect the presence of the substance in the fluid at a concentration of less than or equal to 1 pM.

In a further aspect of the present invention an analyzing device for detecting a substance in a fluid is provided, wherein the analyzing device is adapted to cooperate with a sensing device for detecting the substance, wherein the sensing device comprises:
a sensing region for being used for generating a sensing signal depending on the substance,
a reference region for being used for providing a reference signal,
a reference element covering the reference region, wherein the reference element is adapted to shield the reference region from the substance and to allow the fluid to penetrate the reference element,

wherein the analyzing device comprises:
a signal generation unit for sensing the sensing region for generating a sensing signal and for sensing the reference region for generating a reference signal,
at least one of a) a corrector for correcting the sensing signal depending on the reference signal and b) a wetting determining unit for determining a degree of wetting depending on the reference signal.

In a further aspect of the present invention a sensing method for detecting a substance in a fluid is provided, wherein the sensing method comprises:
sensing a reference region for generating a reference signal by a signal generation unit, wherein a reference element covers the reference region and is adapted to shield the reference region from the substance and to allow the fluid to penetrate the reference element,
sensing a sensing region for generating a sensing signal by the signal generation unit and,
at least one of a) correcting the sensing signal depending on the reference signal by a corrector and b) determining a degree of wetting depending on the reference signal by a wetting determining unit.

In a further aspect of the present invention a manufacturing method for manufacturing a sensing device for detecting a substance in a fluid is provided, wherein the manufacturing method comprises:
providing a sensing region for being used for generating a sensing signal depending on the substance,
providing a reference region for being used for providing a reference signal,
covering the reference region by a reference element, wherein the reference element is adapted to shield the reference region from the substance and to allow the fluid to penetrate the reference element.

It shall be understood that the sensing device of claim 1, the analyzing device of claim 11, the sensing method of claim 12 and the manufacturing method of claim 13 have similar and/or identical preferred embodiments, in particular, as defined in the dependent claims.

It shall be understood that a preferred embodiment of the invention can also be any combination of the dependent claims with the respective independent claim.

These and other aspects of the invention will be apparent from and elucidated with reference to the embodiments described hereinafter.

### BRIEF DESCRIPTION OF THE DRAWINGS

In the following drawings:

FIG. 1 shows schematically and exemplarily an embodiment of a sensing device for detecting a substance in a fluid,

FIG. 2 schematically and exemplarily illustrates a binding of the substance at a sensing region on a sensing surface,

FIG. 3 shows schematically and exemplarily a cartridge,

FIG. 4 shows schematically and exemplarily an analyzing device,

FIG. 5 shows a flowchart exemplarily illustrating an embodiment of a sensing method for detecting a substance in a fluid,

FIG. 6 shows a flowchart exemplarily illustrating an embodiment of a manufacturing method for manufacturing a sensing device for detecting a substance in a fluid, and

FIG. 7 shows a sensing signal and a reference signal.

### DETAILED DESCRIPTION OF EMBODIMENTS

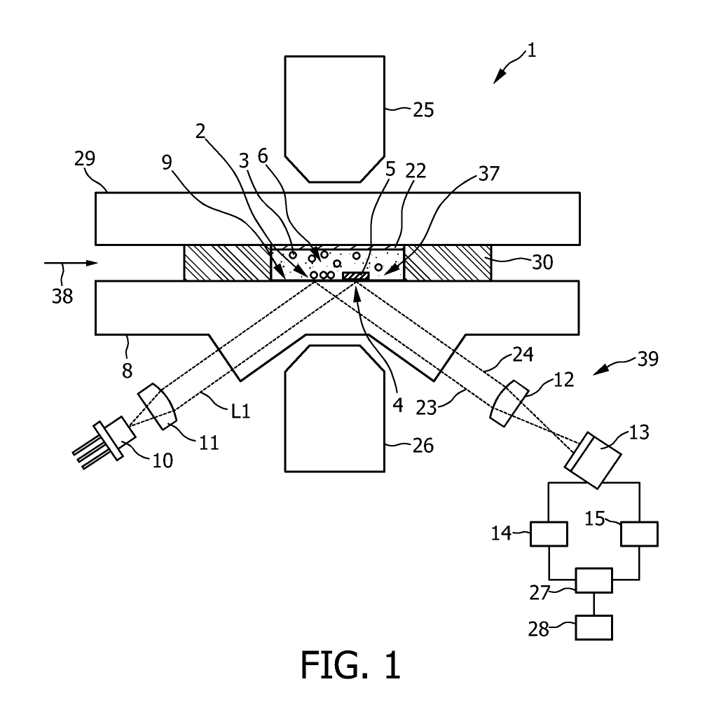

FIG. 1 shows schematically and exemplarily a sensing device 1 for detecting a substance 3 in a fluid 6. The sensing device 1 is a biosensor and comprises a sensing region 2 for being used for generating a sensing signal depending on the substance 3 within the fluid 6. The sensing device 1 further comprises a reference region 4 for being used for providing a reference signal and a reference element 5 covering the reference region 4, wherein the reference element 5 is adapted to shield the reference region 4 from the substance 3 and to allow the fluid 6 to penetrate the reference element 5.

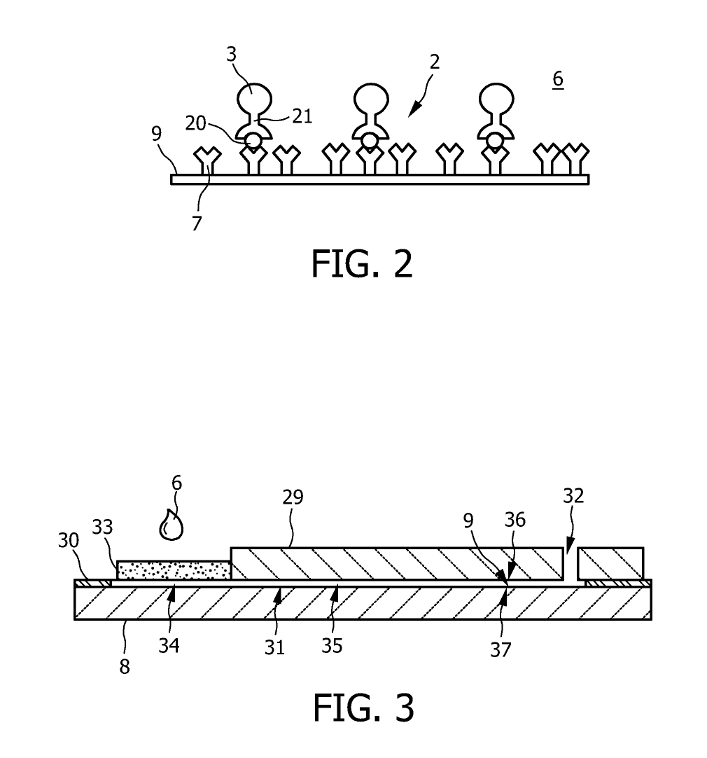

The substance is a particle, in particular, a magnetic particle, which is adapted to attach a target element within the fluid. The magnetic particles with the attached target elements can be bound to the sensing region 4 on a sensing surface 9 of the sensing device 1 by using binding elements. This is schematically illustrated in FIG. 2.

In FIG. 2, the sensing region 2 of the sensing surface 9 comprises binding elements 7 for binding magnetic particles 3 with attaching elements 21 which have attached a target element 20 within the fluid 6. By sensing the amount and/or concentration of the magnetic particles 3 on the sensing surface 9 in the sensing region 2 the amount and/or concentration of the target elements 20 within the fluid 6 can be determined.

The fluid 6 is preferentially a bodily fluid like blood, urine or saliva and the target elements within the bodily fluid, to which the magnetic particles 3 with the attaching elements 21 attach, are, for example, proteins like PSA (prostate cancer) and troponin I which is released during a heart attack, cells like white blood cells or cancer cells, nucleic acids, metabolites, et cetera.

The reference element 5 is a hydrogel that is penetratable by the fluid 6 such that the reference element 5 with the absorbed fluid 6 has substantially the same refractive index as the fluid 6. The hydrogel is a low-weight-percentage hydrogel that absorbs the surrounding fluid very well, and the hydrogel is inkjet-printable such that the reference element 5 can be positioned on the sensing surface 9 very precisely. The reference element 5 on the sensing surface 9 in the reference region 4 is preferentially generated by printing one or several spots of an acrylamide hydrogel solution in the reference region 4 on the sensing surface 9 followed by a crosslinking step, which can be performed directly after printing. The acrylamide hydrogel solution is, for example, a five percent by weight of acrylamide, 0.1 percent by weight of N-N′-methylenebisacrylamide, and two percent by weight of Irgacure 2959 photoinitiator solution in deionized water, and the crosslinking step is preferentially performed by irridating the printed spot by ultraviolet light, in particular, in a nitrogen environment. The percentage values stand for the percentage during manufacture/polymerization of the hydrogel. Thus, in the previously given example, 92.9 percent by weight is water.

The acrylamide is a hydrogel monomer forming hydrogel polymer chains after polymerization, and the bis-acrylamide forms crosslinks between the individual hydrogel polymer chains to form a network. This gives it the property that the hydrogel does not dissolve in the fluid but swells instead. The photoinitiator initiates the polymerization upon exposure to ultraviolet light. The water content during manufacture/polymerization determines the ultimate density of the polymer network.

The binding elements 7 are preferentially also inkjet-printed on the sensing surface 9 in the sensing region 2. The printing of the binding elements 7 onto the sensing surface 9 can be performed before or after the hydrogel solution has been printed to the sensing surface. It is favourable to print and crosslink the hydrogel before printing the binding elements, because this minimizes the exposure of the binding elements 7 to ultraviolet light or another energy like heat used for crosslinking the hydrogel solution.

For improving the adhesion properties between the hydrogel and the sensing surface and/or between the binding elements and the sensing surface, the sensing surface can, for example, be pre-treated by using ultraviolet light and ozone, in particular, if the sensing surface is a plastic surface. If the sensing surface is a glass surface, silane chemistry can be used to chemically bind the hydrogel and/or the binding elements to the sensing surface.

The reference element 5 allows a substantially free movement of the fluid 6, but stops the substance 3 from being arranged at the reference region 4. The substance 3, which consists of, in this embodiment, magnetic particles 3 with the attaching elements 21 having attached the target elements 20 within the fluid 6, are preferentially paramagnetic beads, in particular, superparamagnetic beads. The magnetic particles 3 are preferentially provided by a magnetic particles providing unit 22 which may be arranged on a surface being opposite to the sensing surface 9. If the fluid 6 comes into contact with the magnetic particles providing unit 22, the magnetic particles 3 mix with the fluid 6 and attach the target elements 20 via the attaching elements 21. The magnetic particles providing unit 22 can also be arranged at another location of the sensing device 1 such that the fluid 6 mixes with the provided magnetic particles 3. In an embodiment, the sensing device does not comprise a magnetic particles providing unit and the fluid 6 has already been mixed with the magnetic particles 3, before being introduced into the sensing device.

The sensing device 1 comprises a light source 10 like a light emitting diode for directing incident light L1 to the sensing region 2 and the reference region 4 such that the incident light L1 is reflected under total internal reflection conditions at the sensing region 2 for generating sensing light 23 and at the reference region 4 for generating reference light 24. The sensing device 1 further comprises a detector 13 for generating the sensing signal depending on the sensing light 23 and for generating the reference signal depending on the reference light 24. An optical element 11 is provided for generating parallel light for being directed to the reference region 4 and the sensing region 2 and a further optical element 12 is provided for imaging the reference region and the sensing region on a detection surface of the detector 13. The optical elements 11, 12 are preferentially lenses. In this embodiment, the detector 13 is a camera like a CCD camera for measuring the intensities of the sensing light 23 and the reference light 24. The light source 10, the optical elements 11, 12 and the detector 13 form a signal generation unit 39 for sensing the sensing region 2 for generating a sensing signal and for sensing the reference region 4 for generating a reference signal. The sensing signal is generated by using an FTIR method (Frustrated Total Internal Reflection). If a beam of light reflects on the interface between a medium with a higher refractive index, for example, a carrier 8 with the sensing surface 9, and a lower refractive index, for example, the fluid 6, there is a certain critical angle of incidence above which there is a situation of total internal reflection. The detection configuration, regarding refractive indices and angle of incidence, is such that there is total internal reflection of the incident beam L1. Although the light is totally reflected in such a situation, there is still penetration of light in a very thin layer of the medium with the low refractive index. This is called evanescent light, wherein the intensity of which decays exponentially in the lower refractive index medium with a characteristic penetration depth of the order of the wavelength of the light. In practise, the penetration depth is preferentially less than 0.5 μm. If the magnetic particles 3 are bound to the sensing surface 9, the optical properties of this very thin layer of preferentially about 0.5 μm are changed, leading to a reduction of the intensity of the reflected light beam, i.e. of the sensing light 23. This is caused by absorption and scattering of the evanescent light, i.e. by frustrated total internal reflection. As a result, the intensity of the sensing light changes, wherein this change depends on the amount and concentration of the magnetic particles 3 on the sensing surface 9 in the sensing region 2. The change in the sensing signal can therefore be used for determining the amount and/or concentration of magnetic particles in the sensing region 2 and, thus, for determining the amount and/or concentration of the target elements 20 within the fluid 6, which have been attached by the attaching elements 21 of the magnetic particles 3. The relations between the change of the sensing signal and the amount and/or concentration of the magnetic particles in the sensing region and the concentration and/or amount of the target elements within the fluid 6 can be determined by calibration measurements, wherein these relations can be finally used for determining the amount and/or concentration of currently present magnetic particles and/or target elements.

The reference element 5 allows a substantially free movement of the fluid 6, but stops the magnetic particles 3 from being arranged at the reference region 4. In particular, the sensing device 1 is adapted to be used for generating an evanescent field in the sensing region 2 and in the reference region 4, wherein the sensing region 2 is adapted to be used to generate the sensing signal depending on the presence of the magnetic particles 3 within the evanescent field in the sensing region 2, and wherein the reference element 5 is adapted to shield the reference region 4 such that the magnetic particles 3 are prevented from entering the evanescent field in the reference region 4.

Since the reference element is preferentially adapted to have substantially the same refractive index as the fluid, after the fluid has been absorbed by the reference element, at the reference region substantially the same amount of light will be reflected towards the detector as at the rest of the reflecting surface. In contrast, if the reference element would have a substantially different index of refraction, the incident light may hardly be reflected or may not be reflected at the reference region.

The sensing device 1 further comprises a corrector 14 for correcting the sensing signal depending on the reference signal. The corrector 14 is adapted to correct a drift in the sensing signal depending on the reference signal. The drift correction can be performed, for example, by multiplying a currently generated sensing signal with a factor defined by the ratio of an initially measured reference signal and a currently measured reference signal. The initially measured reference signal is a reference signal, which has been measured at a predefined, in particular, arbitrary, but fixed time. Thus, the drift of the reference signal is used for correcting the sensing signal. For example, if the sensing signal is 45, but the reference signal has dropped from 100 percent to 90 percent, the corrected sensing signal is preferentially 45·100/90=50. The drift can be caused by, for example, temperature fluctuations, deformations, changes in intensity of the incident light L1, et cetera.

The sensing device 1 further comprises a wetting determining unit 15 for determining a degree of wetting depending on the reference signal. The refractive index of the reference element 5 depends on the degree of penetration of the reference element 5 by the fluid 6, and this change in refractive index modifies the intensity of the reference light 24. Thus, the degree of wetting can be determined based on changes in the intensity of the reference light. A relation between the degree of wetting and the change of the reference signal can be determined by calibration measurements with known degrees of wetting, and these relations can be used by the wetting determining unit 15 for determining a currently present degree of wetting depending on the intensity change of the reference signal.

Preferentially, after the fluid 6 has been introduced into the sensing device, firstly the reference signal is used for determining the degree of wetting only, wherein a sensing signal is used, in particular, generated, only after the degree of wetting has reached its maximum constant value. Then, intensity changes of the reference light are not caused anymore by a change in the degree of wetting, but by other effects like the above mentioned temperature fluctuations, deformations, changes in the intensity of the incident light, et cetera. The sensing signal is then corrected by using the reference signal, and the corrected sensing signal is used for determining the amount and/or concentration of the target elements within the fluid.

In a further embodiment, besides the sensing region and the reference region a further region can be provided on the sensing surface being a wetting region. A wetting element, which is also a hydrogel and can be made of the same material as the reference element, is arranged at the wetting region for influencing the wetting signal depending on the degree of penetration of the wetting element by the fluid. Also the wetting region can be illuminated by the incident light under total internal refraction conditions, wherein the light reflected at the wetting region is regarded as wetting light which is detected by the detector for generating a wetting signal. Intensity changes of this wetting signal can be used by the wetting determining unit for determining the degree of wetting as described above.

The sensing device 1 is adapted to be used to detect the presence of the substance in the fluid and, in particular, of the target elements, at a concentration of less than or equal to 1 pM.

The reference region 4 is located adjacent to the sensing region 2. It is therefore highly probable that influences on the reference signal, which are not caused by the magnetic particles, also influence the sensing signal.

The sensing device 1 further comprises magnets 25, 26, in particular, electromagnets, for forcing the magnetic particles 3 towards and away from the sensing surface 9. For example, the magnets 25, 26 can be adapted to force the magnetic particles 3 towards the sensing surface 9, in order to allow the magnetic particles 3, which have attached a target element 20 via the attaching element 21, to be bound in the sensing region 2 via the binding elements 7. Then, in a washing step the magnetic particles 3, which have not been bound to the sensing surface 9, are forced away from the sensing surface 9 by the magnets 25, 26. After the magnetic particles 3 have been forced away from the sensing surface 9, the sensing signal is used for determining the amount and/or concentration of the target element 20 within the fluid 6. This determination of the amount and/or concentration of the target element 20 within the fluid 6 is preferentially performed by an amount determining unit 27 of the sensing device 1. The determined amount and/or concentration of the target element 20 within the fluid 6 can be shown on a display 28.

The sensing device 1 further comprises a cover element 29, which forms together with the carrier 8 and a double-sided tape 30, which is adhesive at two opposing surfaces for attaching the carrier 8 and the cover element 29 to each other, a detection chamber 37 comprising the sensing surface 9 with the sensing region 2 and the reference region 4. The magnetic particles providing unit 22 is arranged on a surface of the cover element 29 being opposite to the sensing surface 9.

A schematic cross-sectional side view from the direction indicated in FIG. 1 by the arrow 38 of the carrier 8, the double-sided tape 30 and the cover element 29 is exemplarily shown in FIG. 3. A filter element 33 is provided for filtering the fluid 6 and an adhesive capillary structure 31 is formed by the carrier 8, the cover element 29 and the double-sided tape 30. The sensing device comprises a filtering location 34, at which the filter element 33 is located, and a detection location 36, at which the magnetic particles 3 can be detected, wherein the capillary structure 31 is formed such that the filtered fluid 6 is guided from the filtering location 34 to the detection location 36 via a capillary connecting channel 35 by capillary forces. The connecting channel 35 has two widths, a smaller width between the filtering location 34 and the detection location 36 and a larger width at the detection location 36 for forming, in this embodiment, the detection cavity 37. The cover element 29 comprises a vent 32 for allowing gas to leave the capillary structure 31.

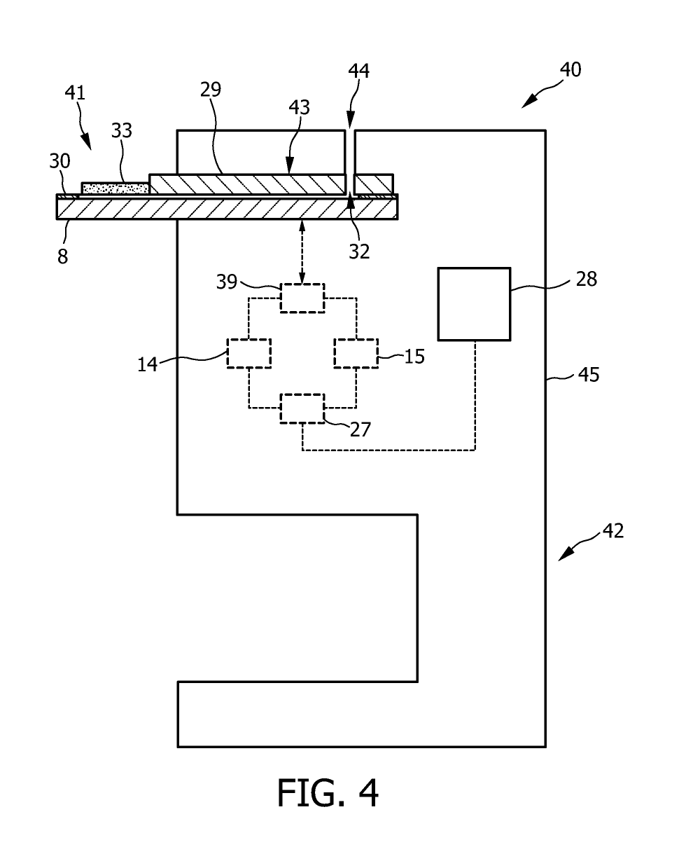

Although with reference to FIG. 1 the sensing device has been described as comprising the several elements shown in FIG. 1, the sensing device can also be a cartridge comprising a carrier with a sensing surface, on which the sensing region and the reference region are provided. In particular, the sensing device can be a cartridge comprising the elements shown in FIG. 3. The further elements like the signal generation unit, the magnets, the corrector, the wetting determining unit, the amount determining unit and the display can be provided by an analyzing device. Thus, the sensing device can be a cartridge being preferentially a disposable device, and the analyzing device can be adapted to be used several times with several disposable cartridges. The analyzing device can be a handheld device as schematically and exemplarily shown in FIG. 4.

The analyzing device 40 shown in FIG. 4 comprises a receiving section 43 for receiving the cartridge 41 which is similar to the cartridge described above with reference to FIG. 3. The receiving section 43 is formed in a casing 45 of the analyzing device 40. The casing 45 further comprises a vent opening 44 which is configured such that it is aligned with the vent 32 of the cartridge 41, if the cartridge 41 has been introduced into the receiving section 43. The signal generation unit 39, the corrector 14, the wetting determining unit 15 and the amount determining unit 27 are also arranged within the casing 45 of the analyzing device 40. The analyzing device 40 further comprises the display 28 for displaying the determined amount and/or concentration of the target element 20 within the fluid 6. The casing 45 comprises a grip part 42 allowing a user to hold the analyzing device 40 in the hand. In another embodiment, the analyzing device can also be a system which is not adapted to be held in the hand, but, for example, to be placed on a table or the like. The housing 45 also houses the magnets 25, 26 which are not shown in FIG. 4 for clarity reasons.

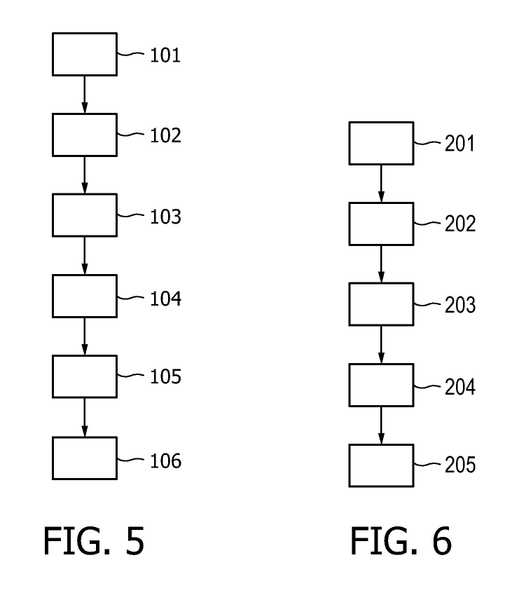

In the following an embodiment of a sensing method for detecting a substance in a fluid will exemplarily be described with reference to a flowchart shown in FIG. 5.

In step 101, a fluid, in particular, a bodily fluid like blood, urine or saliva, is provided on the filter element 22 for filtering the fluid 6, and the filtered fluid is transferred to the detection location 36 with the detection chamber 37. The fluid 6 mixes with the magnetic particles 3 having the attaching elements 21, wherein the magnetic particles 3 with the attaching element 21 are provided by the magnetic particles providing unit 22. The attaching elements 21 attach to target elements 20 within the fluid 6. If the sensing device is a cartridge 41 for cooperating with an analyzing device 40, the cartridge 41 is introduced into the receiving section 43 of the analyzing device 40.

In step 102, the reference region 4 is sensed for generating a reference signal by the signal generation unit 39, and in step 103, the wetting determining unit 15 determines the degree of wetting of the reference region and, thus, of the neighbored sensing region, depending on the reference signal. If the degree of wetting has reached a maximal constant value, the method continues with step 104.

In step 104, the magnets 25, 26 force the magnetic particles 3 onto the sensing surface 9 within the detection chamber 37. In the sensing region 2 the magnetic particles 3, which have attached a target element 20 via the attaching element 21, are bound by the binding elements 7. Then, the magnetic particles 3, which have not been bound to the sensing surface 9, are forced away from the sensing surface 9 using a magnetic field applied with magnets 25, 26.

In step 105, the sensing region 2 is sensed for generating a sensing signal and the reference region 4 is sensed for generating a reference signal. In step 106, the sensing signal is corrected depending on the reference signal by the corrector 14.

In another embodiment, the method does not comprise the step of determining the degree of wetting, i.e. steps 102 and 103 can be omitted, wherein step 104 is performed without considering a determined degree of wetting.

In the following an embodiment of a manufacturing method for manufacturing a sensing device for detecting a substance in a fluid will be exemplarily described with reference to a flowchart shown in FIG. 6.

In step 201 a carrier 8 comprising a sensing surface 9 with a sensing region 2 and with a reference region 4 is provided. In step 202, a hydrogel solution is printed on the reference region 4, and in step 203 the hydrogel solution is crosslinked for providing a reference element 5 on the reference region 4. Then, in step 204, the binding elements 7 are provided in the sensing region 2, in particular, by printing binding elements 7 on the sensing surface 9 in the sensing region 2. In an optional following step 205, the carrier 8 is integrated into a cartridge for manufacturing the cartridge as the sensing device. For example, the carrier 8 can be attached to the cover element 29 by using the adhesive tape 30 comprising the capillary structure 31 for forming the cartridge, wherein preferentially the filter element 33 is provided at the filtering location 34 as described above with reference to FIG. 3.

If the fluid is injected into the cartridge, capillary forces force the fluid to the reference element which swells and which can thereby generate an open gel network which has preferentially the same refractive index as the surrounding fluid. The wetting can be measured almost instantly inside the reference element, i.e. if the reference region is shown on an FTIR image captured by the detector 13, the image pixels within the reference region show almost instantly the wetting of the reference region. Moreover, the outer rims of the reference region comprising the reference element can show a slight delay of wetting. This can be overcome by optimizing the polymerization. The reference signal for wetting detection can be generated by integrating over all pixels of the FTIR image, which correspond to a reference element, or by integrating over an inner region of the pixels corresponding to the reference element. In a preferred embodiment, the reference signal for wetting detection is generated by integrating over an inner region of the pixels corresponding to the reference element such that the edge of the reference element is not included by the inner region, in order to not influence the wetting detection by edge effects.

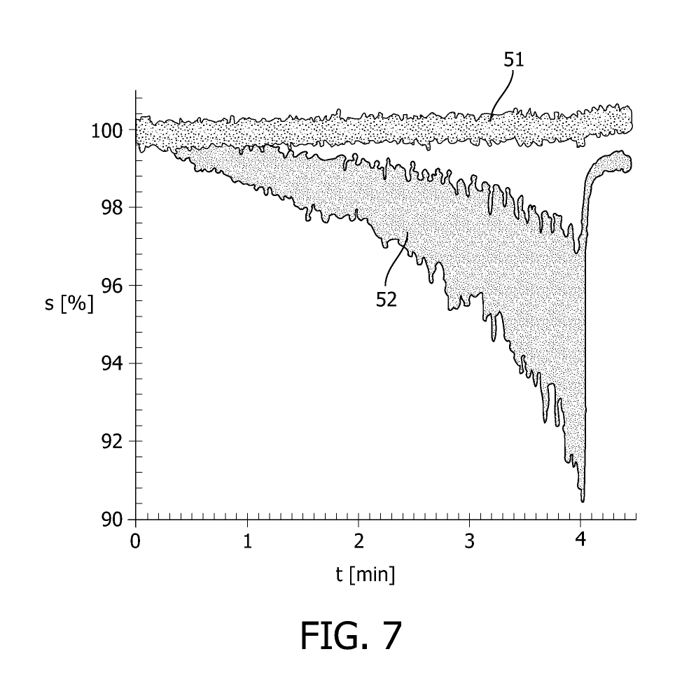

The reference element is adapted to reduce the amount of magnetic particles present at the reference region, in particular, the reference element is adapted to block the presence of the magnetic particles at the reference region. FIG. 7 shows the reference signal and the sensing signal, if the reference element substantially blocks the presence of the magnetic particles at the reference region.

FIG. 7 shows exemplarily the reference signal 51 and the sensing signal 52 depending on the time t normalized to the respective signal at t=0. In the first four minutes the magnetic particles are forced onto the sensing surface by the magnets. This leads to a decreasing sensing signal 52, wherein, if after four minutes the magnetic particles, which have not bound to the sensing surface, are forced away from the sensing surface by the magnets, the sensing signal 52 increases. The reference signal 51 is substantially unaffected by the magnetic particles on the sensing surface, because the reference element shields the magnetic particles from the reference region. The reference signal 51 is only derived from the noise of the detection system and is used as a white reference for correcting the sensing signal.

The sensing device is preferentially adapted to allow detecting a drift of the sensing signal and of the reference signal, which is smaller than 2 promille and further preferred smaller than 1 promille.

The blocking properties of the hydrogel can be adapted as desired by modifying the density of the hydrogel. If the density of the hydrogel is increased, for example, by increasing the amount of monomer (acrylamide), the blocking property of the hydrogel can be increased, in particular, such that the magnetic particles cannot penetrate the evanescent field.

The sensing device can be adapted for detecting specific nucleic acids like DNA and RNA, proteins and metabolites (immuno-assays), that are biomarkers for diseases in the human body. The sensing device can be adapted to perform immuno-assay techniques that use the specific coupling, in particular, through antibody-metabolite/protein interaction, of small paramagnetic beads, i.e. paramagnetic particles, to a surface for the final optical detection of the biological markers, in particular, by FTIR. The sensing device can be adapted for decentralized measurements such as a roadside testing of Drugs-Of-Abuse in saliva or a Point-Of-Care testing of cardiac markers in human blood at the physicians place. The concentration of biological markers in Drugs-Of-Abuse testing is relatively large, i.e. in the nano-molar (nM) region, while the concentrations required for cardiac marker testing are much lower, i.e. in the pico-molar (pM) region. The sensing device can be adapted to detect these low concentrations. The sensing device can further be adapted to detect even lower concentrations in the femto-molar (fM) region. A measurement of these low concentrations is currently only possible in centralized labs where extensive systems are used and measurement times are long. The sensing device in accordance with the invention can be adapted to be operated in a decentralized setting, while still having a centralized lab performance, for example, a dynamic range from fM up to nM detection sensitivity. Especially when measuring low concentrations, the signal becomes relative small, leading to an inferior signal-to-noise ratio due to fluctuations in the measurement device, such as thermal drift, fluctuations in the camera and non-constant illumination conditions. The sensing device is therefore preferentially adapted to detect this system drift and to compensate this system drift. The reference region with the reference element is preferentially adapted such that specific and a specific binding of particles, in particular, of beads, cannot occur in the reference region. The reference region is therefore a local white reference. This white reference is used to correct for the noise and especially the drift in noise close to the sensing region, where the binding elements are located. This lowers the detection limit, in particular, to the sub-pM regime. The reference element is preferentially adapted such that it does not interfere with an immuno-assay or fluid flow.

Although the above described embodiments use an FTIR technique, in other embodiments other techniques like techniques based on influences on magnetic fields can be used for sensing the sensing region and the reference region.

The substance, which is detected on the sensing surface, is preferentially a nanoparticle, in particular, a superparamagnetic nanoparticle or a gold nanoparticle.

Although in the above described embodiments the magnetic particles bound at the sensing region are detected, wherein the amount of the detected particles is used for detecting a target element within the fluid, the sensing device can also be adapted to detect a target element within the fluid directly, wherein a signal generation unit is used, which generates a sensing signal by sensing the target element of this fluid present in the sensing region directly.

The sensing device can comprise one or several sensing regions. If the sensing device comprises several sensing regions, preferentially adjacent to each sensing region a reference region is located, and for correcting a sensing signal, which corresponds to a certain sensing region, a reference signal is used, which corresponds to an adjacent reference region.

The signal generation unit can be any suitable sensor to detect the presence of magnetic particles on or near to the sensing surface, based on any property of the particles, for example, it can detect via magnetic methods (for instance magnetoresistive, Hall, coils), optical methods (for instance imaging, fluorescence, chemiluminescence, absorption, scattering, evanescent field techniques, surface plasmon resonance, Raman, et cetera), sonic detection (for instance surface acoustic wave, bulk acoustic wave, cantilever, quartz crystal, et cetera), electrical detection (for instance conduction, impedance, amperometric, redox cycling), combinations thereof, et cetera. In particular, the signal generation unit can comprise any suitable sensor based on the detection of the magnetic properties of the particles on or near to the sensing surface, for instance, a coil, a magneto-resistive sensor, a magneto-restrictive sensor, a Hall sensor, a planar Hall sensor, a flux gate sensor, a SQUID, a magnetic resonance sensor, et cetera.

The sensing device and/or the analyzing device can be adapted to detect target elements being molecular targets. Molecular targets often determine the concentration and/or presence of larger moieties, for instance cells, viruses, or fractions of cells or viruses, tissue extract, et cetera. The sensing device and/or the analyzing device can also be adapted to detect larger moieties directly, i.e. in addition to molecular assays, also larger moieties can be detected directly, for example cells, viruses, or fractions of cells or viruses, tissue extract, et cetera.

The sensing and reference signals can be derived as an end-point measurement, as well as by recording signals kinetically or intermittently.

The particles can be further processed prior to detection. An example of further processing is that materials are added or that the (bio)chemical or physical properties of the magnetic particles are modified to facilitate detection.

The sensing device and sensing method can be used with several biochemical assay types, for example, binding/unbinding assay, sandwich assay, competition assay, displacement assay, enzymatic assay, et cetera.

The sensing device and method of this invention are suited for sensor multiplexing (i.e. the parallel use of different sensors and sensor surfaces), label multiplexing (i.e. the parallel use of different types of labels, i.e. magnetic particles) and chamber multiplexing (i.e. the parallel use of different reaction chambers, in particular, of different detection chambers).

The sensing device described in the present invention can be used as rapid, robust, and easy to use point-of-care biosensor for small sample volumes. The reaction chamber, in particular, the detection chamber, can be a disposable item, i.e. a sensing cartridge, to be used with a compact reader, i.e. the analyzing device, containing one or more magnetic field generating means and one or more signal generation units. Also, the sensing device and method of the present invention can be used in automated high-throughput testing. In this case, the reaction chamber, i.e. the detection chamber, is for instance a well plate or cuvette, fitting into an automated instrument, in particular, fitting into the analyzing device.

The magnetic particles are preferentially nanoparticles having at least one dimension ranging between 3 nm and 5000 nm, further preferred between 10 nm and 3000 nm, and even further preferred between 50 nm and 1000 nm.

Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality.

A single unit or device may fulfill the functions of several items recited in the claims. The mere fact that certain measures are recited in mutually different dependent claims does not indicate that a combination of these measures cannot be used to advantage.

Determinations like the determination of the amount and/or concentration of a target element within the fluid or like the determination of the degree of wetting, or the correction of the sensing signal depending on the reference signal, performed by one or several units or devices can be performed by any other number of units or devices. For example, steps 103 and 106 can be performed by a single unit or by any other number of different units. The determinations, corrections and/or the control of the sensing device and/or of the analyzing device in accordance with the above mentioned sensing method can be implemented as program code means of a computer program and/or as dedicated hardware.

A computer program may be stored/distributed on a suitable medium, such as an optical storage medium or a solid-state medium, supplied together with or as part of other hardware, but may also be distributed in other forms, such as via the Internet or other wired or wireless telecommunication systems.

Any reference signs in the claims should not be construed as limiting the scope.

The invention relates to a sensing device for detecting a substance in a fluid, wherein the sensing device comprises a sensing region for being used for generating a sensing signal depending on the substance, a reference region for being used for providing a reference signal, and a reference element covering the reference region. The reference element is adapted to shield the reference region from the substance and to allow the fluid to penetrate the reference element. This reduces the influence of the reference signal by the substance and, since the reference element is adapted to allow the fluid to penetrate the reference element, differences regarding properties of the fluid at the sensing region and of the reference element at the reference region can be reduced. This reduction leads to an improved reference signal, which can be used, for example, for correcting the sensing signal.

1. A sensing device for detecting a substance in a fluid by using frustrated total internal reflection, wherein the sensing device comprises
a sensing region for being used for generating a sensing signal depending on the substance,
a reference region for being used for providing a reference signal,
a reference element covering the reference region, wherein the reference element is adapted to shield the reference region from the substance and to allow the fluid to penetrate the reference element,
wherein the sensing device is adapted to be used for generating an evanescent field for frustrated total internal reflection in the sensing region and in the reference region, wherein the sensing region is adapted to be used to generate the sensing signal depending on the presence of the substance in the evanescent field in the sensing region and wherein the reference element is adapted to shield the reference region such that the substance is prevented from entering the evanescent field in the reference region.

2. The sensing device according to claim 1, wherein the reference element comprises hydrogel.

3. (canceled)

4. The sensing device according to claim 1, wherein the reference element comprises an inkjet-printable material.

5. The sensing device according to claim 1, wherein the reference element comprises a contact-printable material.

6. The sensing device according to claim 1, wherein the reference region is adjacent to the sensing region.

7. The sensing device according to claim 1, further comprising
a signal generation unit for sensing the sensing region for generating a sensing signal and for sensing the reference region for generating a reference signal, and
at least one of a) a corrector for correcting the sensing signal depending on the reference signal and b) a wetting detector for determining a degree of wetting depending on the reference signal.

8. The sensing device according to claim 7, wherein the corrector (15) is adapted to correct a drift in the sensing signal depending on the reference signal.

9. The sensing device according to claim 1, wherein the signal generation unit comprises:
a light source for directing incident light to the sensing region and the reference region such that the incident light is reflected under total internal reflection conditions at the sensing region for generating sensing light and at the reference region for generating reference light, and
a detector for generating the sensing signal depending on the sensing light and for generating the reference signal depending on the reference light.

10. The sensing device according to claim 1, wherein the sensing device is adapted to cooperate with an analyzing device for detecting the substance in the fluid, wherein the analyzing device comprises:
a signal generation unit for sensing the sensing region for generating a sensing signal and for sensing the reference region for generating a reference signal,
at least one of a) a corrector for correcting the sensing signal depending on the reference signal and b) a wetting determining unit for determining a degree of wetting depending on the reference signal.

11. (canceled)

12. A sensing method for detecting a substance in a fluid by using frustrated total internal reflection, the sensing method comprising:
sensing a reference region for generating a reference signal by a signal generation unit, wherein a reference element covers the reference region and is adapted to shield the reference region from the substance and to allow the fluid to penetrate the reference element,
sensing a sensing region for generating a sensing signal by the signal generation unit and,
at least one of a) correcting the sensing signal depending on the reference signal by a corrector and b) determining a degree of wetting depending on the reference signal by a wetting determining unit
wherein in the sensing region and in the reference region an evanescent field for frustrated total internal reflection is generated, wherein the sensing region is used to generate the sensing signal depending on the presence of the substance in the evanescent field in the sensing region and wherein the reference element shields the reference region such that the substance is prevented from entering the evanescent field in the reference region.

13. A manufacturing method for manufacturing a sensing device for detecting a substance in a fluid by using frustrated total internal reflection, the manufacturing method comprising:
providing a sensing region for being used for generating a sensing signal depending on the substance,
providing a reference region for being used for providing a reference signal,
covering the reference region by a reference element, wherein the reference element is adapted to shield the reference region from the substance and to allow the fluid to penetrate the reference element, wherein the sensing device is adapted to be used for generating an evanescent field for frustrated total internal reflection in the sensing region and in the reference region, wherein the sensing region is adapted to be used to generate the sensing signal depending on the presence of the substance in the evanescent field in the sensing region and wherein the reference element is adapted to shield the reference region such that the substance is prevented from entering the evanescent field in the reference region.
